(19) United States
(12) Patent Application Publication
(10) Pub. No.: US 2014/0225814 A1
(43) Pub. Date: Aug. 14, 2014

(54) METHOD AND SYSTEM FOR REPRESENTING AND INTERACTING WITH GEO-LOCATED MARKERS

(71) Applicants: Edward Robert English, Falls Church, VA (US); Brian Adams Ballard, Herndon, VA (US); Todd Richard Reily, Stoneham, MA (US)

(72) Inventors: Edward Robert English, Falls Church, VA (US); Brian Adams Ballard, Herndon, VA (US); Todd Richard Reily, Stoneham, MA (US)

(73) Assignee: APX Labs, LLC, Herndon, VA (US)

(21) Appl. No.: 14/180,851

(22) Filed: Feb. 14, 2014

Related U.S. Application Data
(60) Provisional application No. 61/764,688, filed on Feb. 14, 2013.

(51) Int. Cl. G02B 27/01

(52) U.S. Cl. CPC G02B 27/017
USPC 345/8

(57) ABSTRACT

Systems and methods for displaying information by a head mounted display (HMD) are disclosed. The method may include identifying a physical context of the HMD. The method may also include identifying, based on the physical context, a geo-located marker associated with an object in a field of view of a user, and displaying the geo-located marker on the HMD. The method may further include detecting a user selection of the geo-located marker and displaying information associated with the object.

This application is based on and claims priority to U.S. Provisional Application No. 61/764,688, filed on Feb. 14, 2013, which is incorporated herein by reference in its entirety.

### TECHNICAL FIELD

The present disclosure relates generally to methods and systems for conveying information of objects and more particularly, to methods and systems for representing and interacting information of objects with geo-located markers.

### BACKGROUND

Technology advances have enabled mobile personal computing devices to become more capable and ubiquitous. In many cases these devices will have both a display as well as a combination of sensors, for example, GPS, accelerometers, gyroscopes, cameras, light meters, and compasses or some combination thereof. These devices may include mobile computing devices as well as bead mounted displays,

These mobile personal computing devices are increasingly capable of both displaying information for the user as well as supplying contextual information to other systems and applications on the device. Such contextual information can be used to determine the location, orientation and movement of the user interface display of the device.

### SUMMARY

In one aspect a bead mounted display (HMD) is provided. The HMD may include (1) a see-through or semi-transparent display (e.g., a display that allows transmission of at least some visible light that impinges upon the HMD) that allows the user to see the real-world environment and to display generated images superimposed over or provided in conjunction with a real-world view as perceived by the wearer through the lens elements and (2) electronic or analog sensors that can establish the physical context of the display. By way of example and without limitation, the sensors could include any one or more of a motion detector (e.g., a gyroscope and/or an accelerometer), a camera, a location determination device (e.g., a GPS device, a NFC reader), a magnetometer, and/or an orientation sensor (e.g., a theodolite, infra-red sensor).

In this aspect, the display on the HMD may include a visual representation of a reticle with a fixed point of reference to the user. Additionally, the display may also provide a visual representation of some number of geo-located markers representing objects or points of interest in three dimensional space that are visible in the user's current field of view.

A user wishing to select a geo-located marker in order to, for example, obtain reference information or digitally interact with it, may physically move the display device such that the reticle rendered on the display will appear in close proximity to a chosen marker also rendered on the display. Holding the display device in this position for a specified period of time may result in selection of the chosen marker. Upon selection, subsequent information may be rendered on the display or some action related to that marker may be executed.

### BRIEF DESCRIPTION OF THE DRAWINGS

FIG. 1 illustrates an exemplary system for implementing embodiments consistent with disclosed embodiments;

FIG. 2 illustrates an exemplary head mounted display (HMD);

FIG. 3a illustrates examples of point references according to a Cartesian coordinate system;

FIG. 3b illustrates examples of point references according to a Spherical coordinate system;

FIG. 4 illustrates an example display of field of view consistent with the exemplary disclosed embodiments;

FIG. 5a is a diagrammatic representation of a reticle consistent with the exemplary disclosed embodiments;

FIG. 5b is another diagrammatic representation of a reticle consistent with the exemplary disclosed embodiments;

FIG. 6 is a diagrammatic representation of a selection vector consistent with the exemplary disclosed embodiments;

FIG. 7 is a diagrammatic representation of a selection plane consistent with the exemplary disclosed embodiments;

FIG. 8 is a diagrammatic representation of an interception of a geo-located marker by a reticle consistent with the exemplary disclosed embodiments;

FIG. 9 is a diagrammatic representation of a selection outcome consistent with the exemplary disclosed embodiments; and

FIG. 10 is a flowchart of an exemplary process for displaying information on a HMD, consistent with disclosed embodiments.

### DETAILED DESCRIPTION

Mobile personal computing devices can be used as a portable display used to interact in interesting ways with the real world. To overlay information or interact with objects in the real-world, points of interest may be defined and associated with locations in three dimensional space, and rendered in such a way that allows the user to visualize them on a display.

The location definition, reference information and the metadata associated with these objects and points of interest can be digitally created, stored and managed by computer applications or through user interaction with computer applications. Visual representations of certain objects and points of interest may be rendered on the device display and associated with objects, people or locations in the real world. Such visual representations may be referred to as “geo-located markers.”

A method and system for enabling users to select and interact with geo-located markers simply by moving the display will in many cases he more efficient, more intuitive, and safer than using peripheral devices and methods (e.g., such as a touch-screen, mouse, or track pad).

Exemplary methods and systems are described herein. It should be understood that the word “exemplary” is used herein to mean “serving as an example, instance, or illustration.” Any embodiment or feature described herein as “exemplary” is not necessarily to be construed as preferred or advantageous over other embodiments or features. The exemplary embodiments described herein are not meant to be limiting. It will be readily understood that certain aspects of the disclosed, systems and methods can be arranged and combined in a wide variety of different configurations, all of which are contemplated herein.

In one exemplary embodiment, a head-mounted display (HMD) is provided that includes a see-through display and sensor systems that provide output from which the device's location, orientation, and bearing (for example, latitude, longitude, altitude, pitch, roll or degree tilt from horizontal and vertical axes, and compass heading) may be determined. The HMD could be configured as glasses that can be worn by a person. Further, one or more elements of the sensor system may be located on peripheral devices physically separate from the display.

Additionally, in one embodiment, the HMD may rely on a computer application to instruct the device to render overlay information on the display field of view. This computer application creates and maintains a coordinate system that corresponds to locations in the real physical world. The maintained coordinate system may include either a two dimensional Cartesian coordinate system, a three dimensional Cartesian coordinate system, a two dimensional Spherical coordinate system, a three dimensional Spherical coordinate system, or any other suitable coordinate system.

The application may use information from the HMD sensor systems to determine where the user of the HMD is located in the coordinate system, and to calculate the points in the coordinate system that are visible in the user's current field of view. The user's field of view may include a two dimensional plane, rendered to the user using one display (monocular) or two displays (binocular). For example, based on output of the sensors associated with the HMD, the location of the user relative to a predetermined coordinate system may be determined as well as the user's orientation relative to other objects defined (or not defined) within the coordinate system. Further, based on the output of the sensors, the direction in which the user is looking may also he determined, and the geo-located objects defined in the coordinate system to be displayed within the user's field of view may be determined. Such sensors may include GPS units to determine latitude and longitude, altimeters to determine altitude, magnetometers (compasses) to determine orientation or a direction that a user is looking, accelerometers (e.g., three axis accelerometers) to determine the direction and speed of movements associated with HMD 200, etc. In some embodiments, computer vision based algorithms to detect markers, glyphs, objects, QR codes and QR code readers may be employed to establish the position of HMD 200.

If the user of the HMD moves (and the HMD moves correspondingly with the user), the sensors in the HMD provide data to the application which may prompt or enable the application to monitor information associated with the display including, for example, the current location, orientation and/or hearing of the display unit. This information, in turn, may be used to update or change aspects of images or information presented to the user within the user's field of view on the display unit.

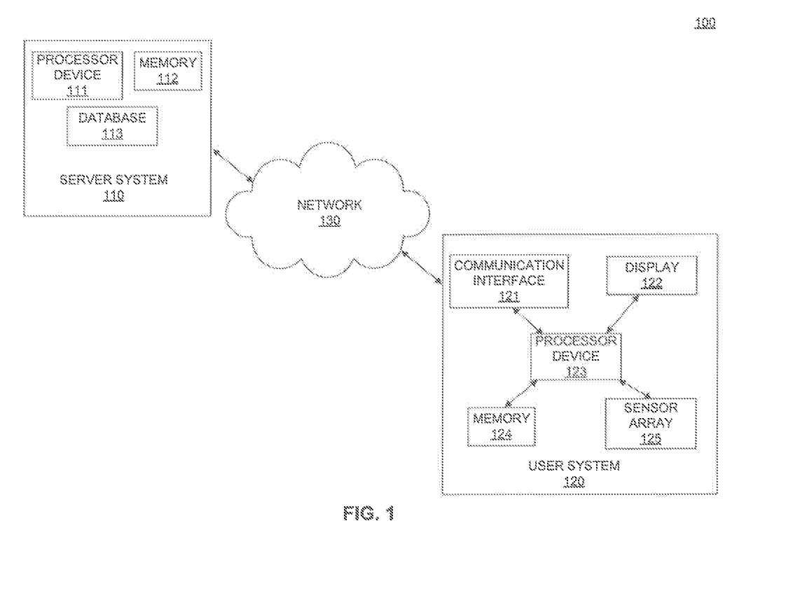

FIG. 1 illustrates an exemplary system 100 for implementing embodiments consistent with disclosed embodiments. In one aspect, system environment 100 may include a server system 110, a user system 120, and network 130. It should be noted that although a single user system 120 is shown in FIG. 1, more than one user system 120 may exist in system, environment 100. Furthermore, although a single server system 110 is shown in FIG. 1, more than one server system 110 may exist in system environment 100.

Server system 110 may be a system configured to provide and/or manage services associated with geo-located markers to users. Consistent with the disclosure, server system 110 may provide information of available geo-located markers to user system 120. Server system may also update the information to user system 120 when the physical position of user system 120 changes.

Server system 110 may include one or more components that perform processes consistent with the disclosed embodiments. For example, server system 110 may include one or more computers, e.g., processor device 111, database 113, etc., configured to execute software instructions programmed to perform aspects of the disclosed embodiments, such as creating and maintaining a global coordinate system, providing geo-markers to users for display, transmit information, associated with the geo-markers to user system 120, etc. In one aspect, server system 110 may include database 113. Alternatively, database 113 may be located remotely from the server system 110. Database 113 may include computing components (e.g., database management system, database server, etc.) configured to receive and process requests for data stored in memory devices of database(s) 113 and to provide data from database 113.

User system 120 may include a system associated with a user (e.g., customer) that is configured to perform one or more operations consistent with the disclosed embodiments. In one embodiment an associated user may operate user system 120 to perform one or more such operations. User system 120 may include a communication interface 1.21, a processor device 123, a memory 124, a sensor array 125, and a display 122. The processor device 123 may be configured to execute software instructions programmed to perform aspects of the disclosed embodiments. User system 120 may be represented in the form of head mounted display (HMDs). Although in the present disclosure user system 120 is described in connection with a HMD, user system 120 may include tablets, mobile phone(s), laptop computers, and any other computing device(s) known to those skilled in the art.

Communication interface 121 may include one or more communication components, such as cellular, WIFI, or Bluetooth transceivers. The display 122 may be a translucent display or semi-transparent display. The display 122 may even include opaque lenses or components, e.g., where the images seen by the user are projected onto opaque components based on input signals from a forward looking camera as well as other computer-generated information. Furthermore, the display 122 may employ a waveguide, or it may project information using holographic images. The sensor array 125 may include one or more GPS sensors, cameras, barometric sensors, proximity sensors, physiological monitoring sensors, chemical sensors, magnetometers, gyroscopes, accelerometers, and the like.

Processor devices 111 and 123 may include one or more suitable processing devices, such as a microprocessor, controller, central processing unit, etc. In some embodiments, processor devices 111 and/or 123 may include a microprocessor from the Pentium™ or Xeon™ family manufactured by Intel™, the Turion™ family manufactured by AMD™, or any of various processors manufactured by Sun Microsystems or other microprocessor manufacturers.

Consistent with disclosed embodiments, one or more components of system 100, including server system 110 and user system 120, may also include one or more memory devices (such as memories 112 and 124) as shown in exemplary form in FIG. 1. The memory devices may store software instructions that are executed by processor devices 111 and 123, such as one or more applications, network communication processes, operating system software, software instructions relating to the disclosed embodiments, and any other type of application or software known to be executable by processing devices. The memory devices may be a volatile or non-volatile, magnetic, semiconductor, tape, optical, removable, nonremovable, or other type of storage device or non-transitory computer-readable medium. The memory devices may be two or more memory devices distributed over a local or wide area network, or may be a single memory device. In certain embodiments, the memory devices may include database systems, such as database storage devices, including one or more database processing devices configured to receive instructions to access, process, and send information stored in the storage devices. By way of example, database systems may including Oracle™ databases, Sybase™ databases, or other relational databases or non-relational databases, such as Hadoop sequence files, HBase, or Cassandra.

In some embodiments, server system 110 and user system 120 may also include one or more additional components (not shown) that provide communications with other components of system environment 100, such as through network 130, or any other suitable communications infrastructure.

Network 130 may be any type of network that facilitates communications and data transfer between components of system environment 100, such as, for example, server system 110 and user system 120. Network 130 may be a Local Area Network (LAN), a Wide Area Network (WAN), such as the Internet, and may be a single network or a combination of networks. Further, network 130 may reflect a single type of network or a combination of different types of networks, such as the Internet and public exchange networks for wireline and/or wireless communications. Network 130 may utilize cloud computing technologies that are familiar in the marketplace. Moreover, any part of network 130 may be implemented through traditional infrastructures or channels of trade, to permit operations associated with financial accounts that axe performed manually or in-person by the various entities illustrated in FIG. 1. Network 130 is not limited to the above examples and system 100 may implement any type of network that allows the entities (and others not shown) included in FIG. 1 to exchange data and information.

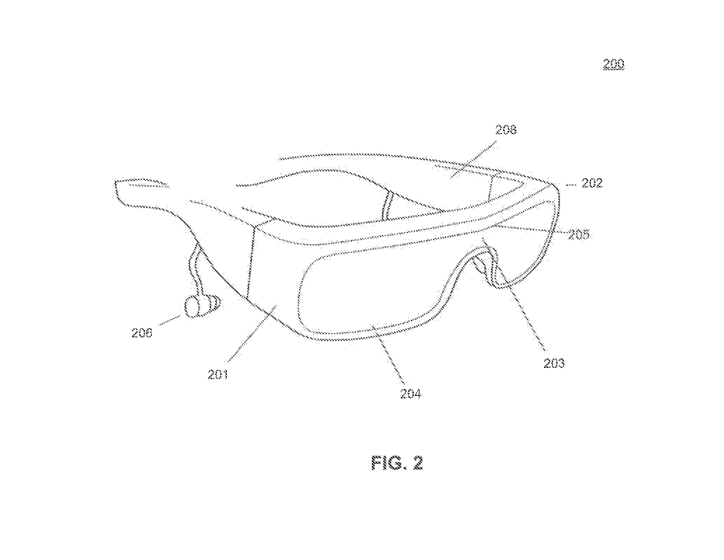

FIG. 2 illustrates an exemplary bead mounted display (HMD) 200. As shown in FIG. 2, the HMD 200 may include features relating to navigation, orientation, location, sensory input, sensory output, communication and computing. For example, the HMD 200 may include an inertial measurement unit (IMU) 201. Typically, IMUs comprise axial accelerometers and gyroscopes for measuring position, velocity and orientation. IMUs may enable determination of the position, velocity and orientation of the HMD within the surrounding real world environment and/or its position, velocity and orientation relative to real world objects within that environment in order to perform its various functions.

The HMD 200 may also include a Global Positioning System (GPS) unit 202. GPS units receive signals transmitted by a plurality of geosynchronous earth orbiting satellites in order to triangulate the location of the GPS unit. In more sophisticated systems, the GPS unit may repeatedly forward a location signal to an EMU to supplement the IMUs ability to compute position and velocity, thereby improving the accuracy of the IMU. In the present case, the HMD 200 may employ GPS to identify a location of the HMD device.

As mentioned above, the HMD 200 may include a number of features relating to sensory input and sensory output. Here, HMD 200 may include at least a front racing camera 203 to provide visual (e.g., video) input, a display (e.g., a translucent or a stereoscopic translucent display) 204 to provide a medium for displaying computer-generated information to the user, a microphone 205 to provide sound input and audio buds/speakers 206 to provide sound output. In some embodiments, the visually conveyed digital data may be received by the HMD 200 through the front facing camera 203.

The HMD 200 may also have communication capabilities, similar to conventional mobile devices, through the use of a cellular, WIFI, Bluetooth or tethered Ethernet connection. The HMD 200 may also include an on-board microprocessor 208. The on-board microprocessor 208, may control the aforementioned and other features associated with the HMD 200.

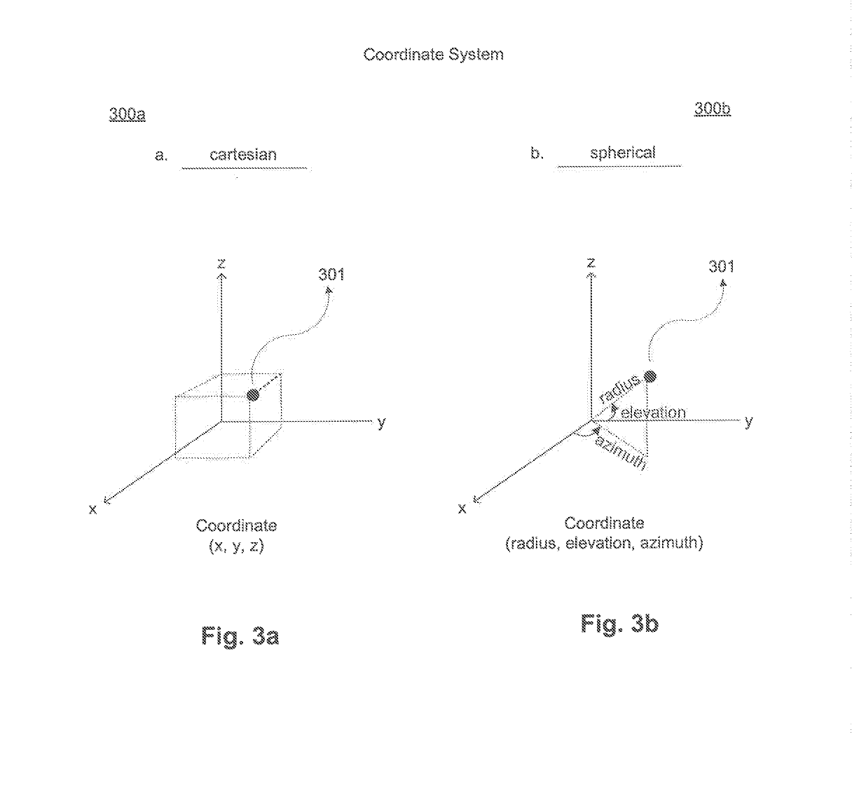

FIG. 3a illustrates examples of point references according to a Cartesian coordinate system 300a. As shown in FIG. 3a, a geo-located marker 301 is located in a Cartesian coordinate system with coordinate (x, y, z). Many such markers may be defined and tracked using such a coordinate system. This information may be maintained in memory 124 associated with HMD 200. Alternatively, or additionally, this information may be maintained in database 113 of server system 110.

FIG. 3b illustrates examples of point references according to a Spherical coordinate system 300b. As shown in FIG. 3b, the geo-located marker 301 can also be expressed as in a Spherical coordinate system with coordinate (radius, elevation, azimuth). The geo-located marker may be represented as a glowing dot or other highlighted item on the display. Any other suitable coordinate system, multiple coordinate systems, or other constructs may be used to define and/or track the locations of geo-located markers 301.

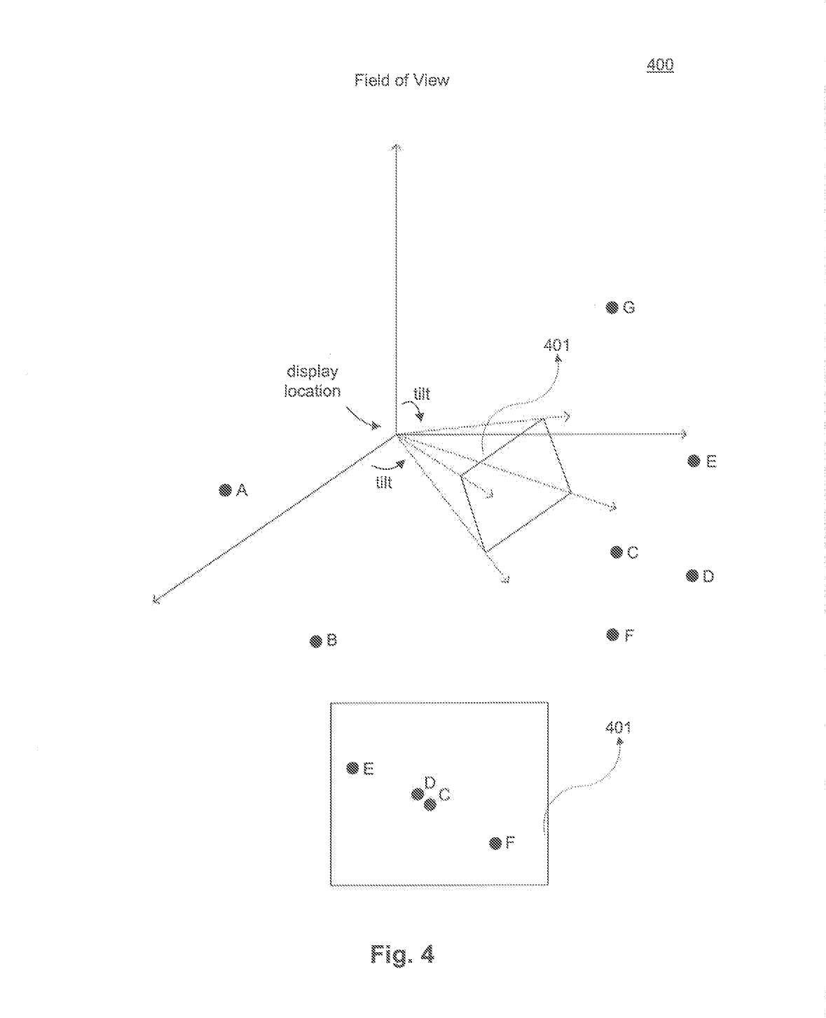

FIG. 4 illustrates an example of a field of view 400 consistent with the exemplary disclosed embodiments. HMD 200 may provide the wearer with a visual representation of geo-located markers which may be associated with objects or points of interest located in a coordinate system. These may be defined, for example, by latitude, longitude and altitude.

The geo-located marker coordinate locations and associated reference and metadata may be stored and managed by a computer application. The computer application instructs or otherwise causes the HMD to display one or more visual elements on the display which correspond to the locations in the coordinate system defined by the geo-located marker. For example, the geo-located markers rendered on the HMD display may correspond to those with coordinates visible in the user's field of view. For example, as shown in FIG. 4, although geo-located markers A-G are located in proximity to the HMD, the user's field of view 401 may include only geo-located markers C, D, E, and F, The positions of markers rendered on the display may change, new markers may appear, or markers may disappear as the display field of view changes. Updating of the display of HMD 200 may be based on an understanding by the system of how the HMD is positioned and oriented within the coordinate system. As the user's field of view changes, those geo-located markers that come into view (or overlap with the user's field of view) may be displayed to the user, while those that move out of the field of view can be removed from the display.

Geo-located markers may include representations of physical objects, such as locations, people, devices, and non-physical objects such as information sources and application interaction options. Geo-located markers may be visually represented on the display as icons, still or video images, or text. Geo-located markers may appear in close proximity, or overlap each other on the display. Such markers may be grouped into a single marker representing a collection or group of markers.

Geo-located markers may persist for any suitable time period. In some embodiments the geo-located markers may persist indefinitely or may cease to exist after use. Geo-located markers may also persist temporarily for any selected length of time (e.g., less than 1 sec, 1 sec, 2 sec, 5 sec, more than 5 sec, etc. after being displayed).

In some embodiments, one geo-located marker may represent a cluster of objects or points of interest. When the geo-located marker is selected, the representation of the marker on the user's display may change into additional or different icons, etc, representative of or associated with the cluster of objects or points in interest. One or more of the subsequently displayed items on the screen may be further selected by the user.

Geo-located markers may be shared across systems, applications and users, or may be locally confined to a single system, application or user.

In some embodiments, the HMD may provide a reticle which serves as a representation of a vector originating at a fixed location relative to the user and projecting in a straight line out into the coordinate system. Such a reticle may assist the user in orienting the HMD device relative to their real-world environment as well as to geo-located markers which may be rendered on the user's display in locations around the user.

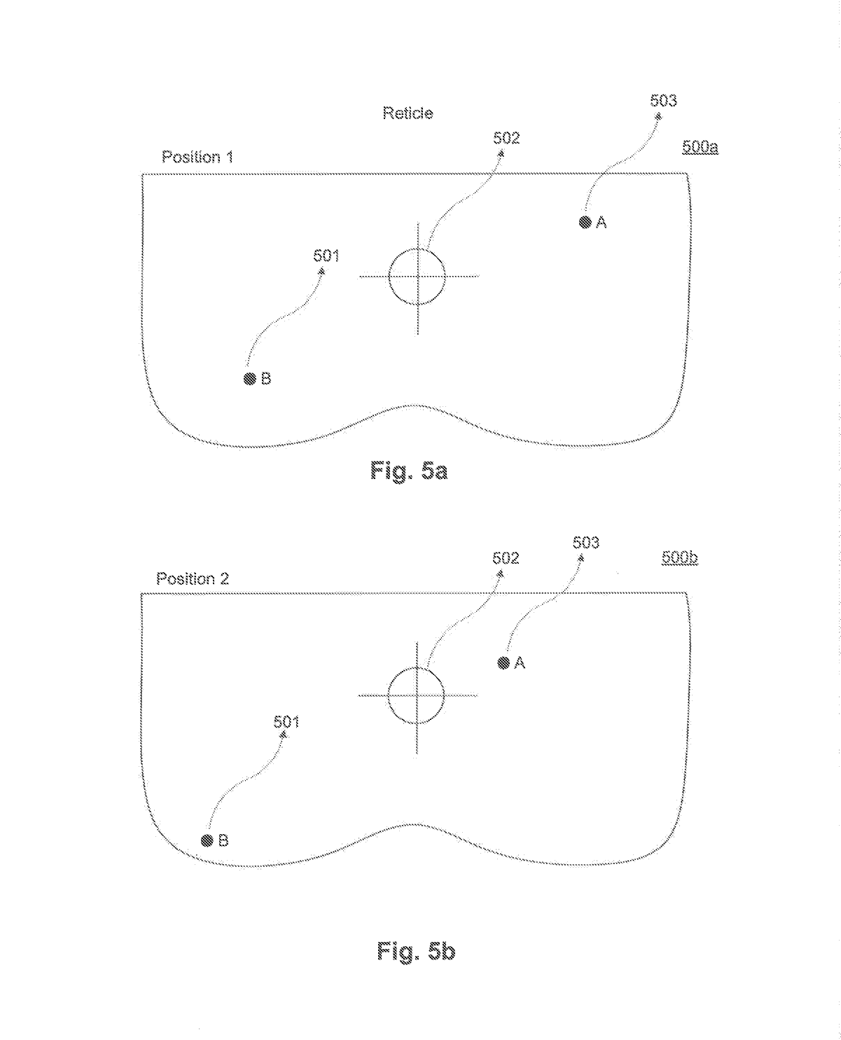

FIG. 5a is a diagrammatic representation of a reticle 500a consistent with the exemplary disclosed embodiments. As shown in FIG. 5a, a reticle 502 may be included in a user's field of view, along with the geo-located markers such as 501 and 503. FIG. 5b also represents the appearance of the reticle 500b relative to objects or geo-located markers A and B as the field of view of an HMD, according to some embodiments, changes. It can be seen that in FIG. 5b, the relative position between the reticle 502 and the geo-located markers 501 and 503 changes as a result of the movement of the HMD device. Reticle 502 may have any suitable shape. In some embodiments, it may be represented as a cross shape, a dot, a circle, square, etc.

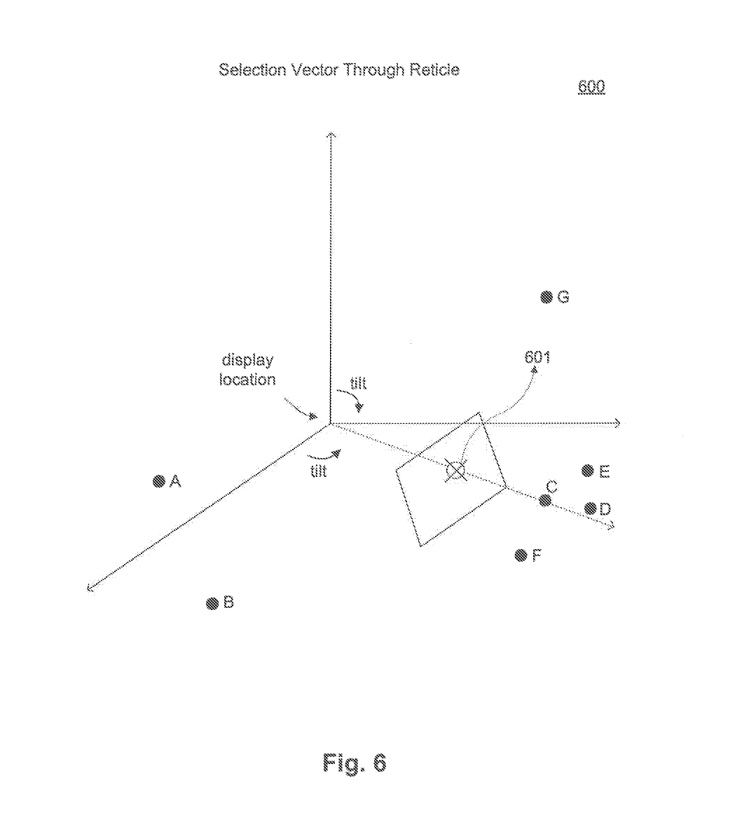

FIG. 6 is a diagrammatic representation of a selection vector 600 consistent with the exemplary disclosed embodiments. As shown in FIG. 6, a selection vector may be defined by the position of the reticle 601. Any object on the selection vector may be determined to be selected by the user. In this example, geo-located marker C would be selected since it is located on the selection vector.

In some embodiments, the reticle may be represented on the display as one or more icons, still or video images, or text. Various aspects of the reticle may change to provide user feedback. For example, any of the size, color, shape, orientation, or any other attribute associated with the reticle may be changed in order to provide feedback to a user.

The reticle position on the display may be modified or changed. For example it may be rendered in the center of the field of view of the user, or at any other location on the field of view of the user.

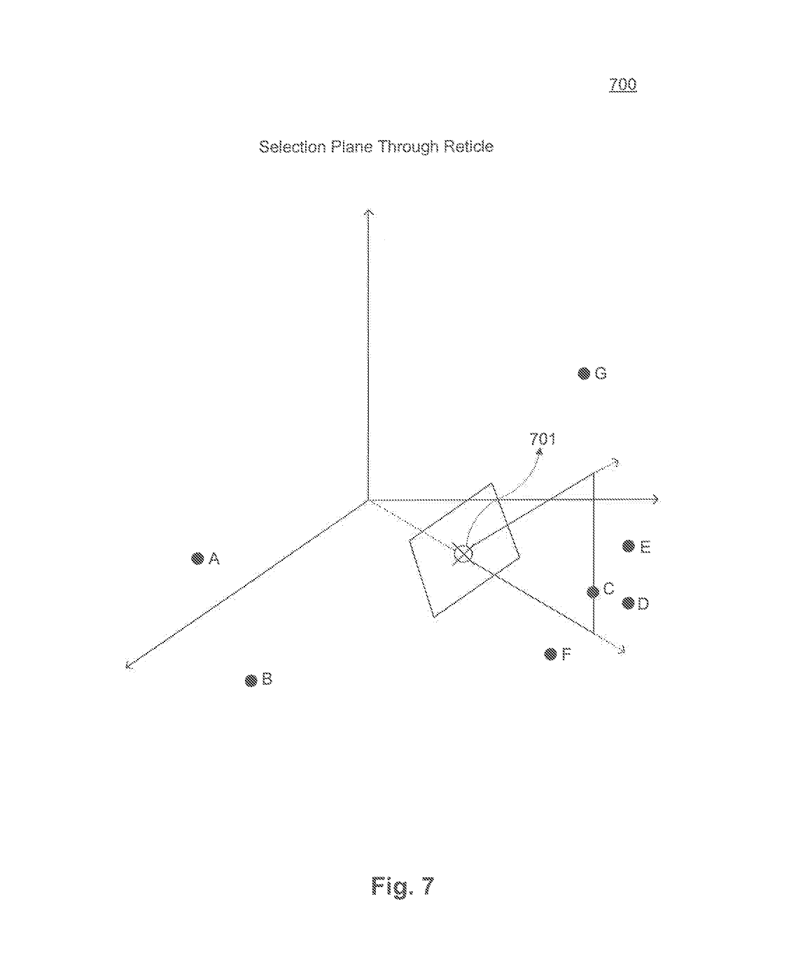

Alternatively or additionally, the vector may be implemented as a plane rather than as a line. FIG. 7 is a diagrammatic representation of a selection plane 700 consistent with the exemplary disclosed embodiments. As shown in FIG. 7, a selection plane may be defined by the position of the reticle 701. Any object on the selection plane may be determined to be selected by the user. In this example, geo-located marker C would be selected since it is located on the selection plane. Physically moving the display will cause the field of view to move, and the reticle may move correspondingly relative to the scene associated with the field of view. In some embodiments, moving the reticle may represent a movement of the vector through the coordinate system.

In the field of view, the reticle may be fixed relative to the display, but the geo-located objects may be free to move in and out of the field of view. Thus, in some embodiments, the user can move the display such that the reticle overlaps a geo-located marker on the display. This action causes the vector to intercept a geo-located object in the coordinate system.

In some embodiments, when the vector overlaps a geo-located object, and the user holds this overlap in a stable position for an amount of time, this may trigger an application event to select that marker and initiate a system response. The desired time to hold in place (e.g., “dwell time”) may be configurable and machine learnable.

Proximity of overlap may employ logic to assist the user in their action. For example, the application may utilize snap logic or inferred intent such that exact pixel overlay between the reticle and the geo-located object marker may not be required for selection.

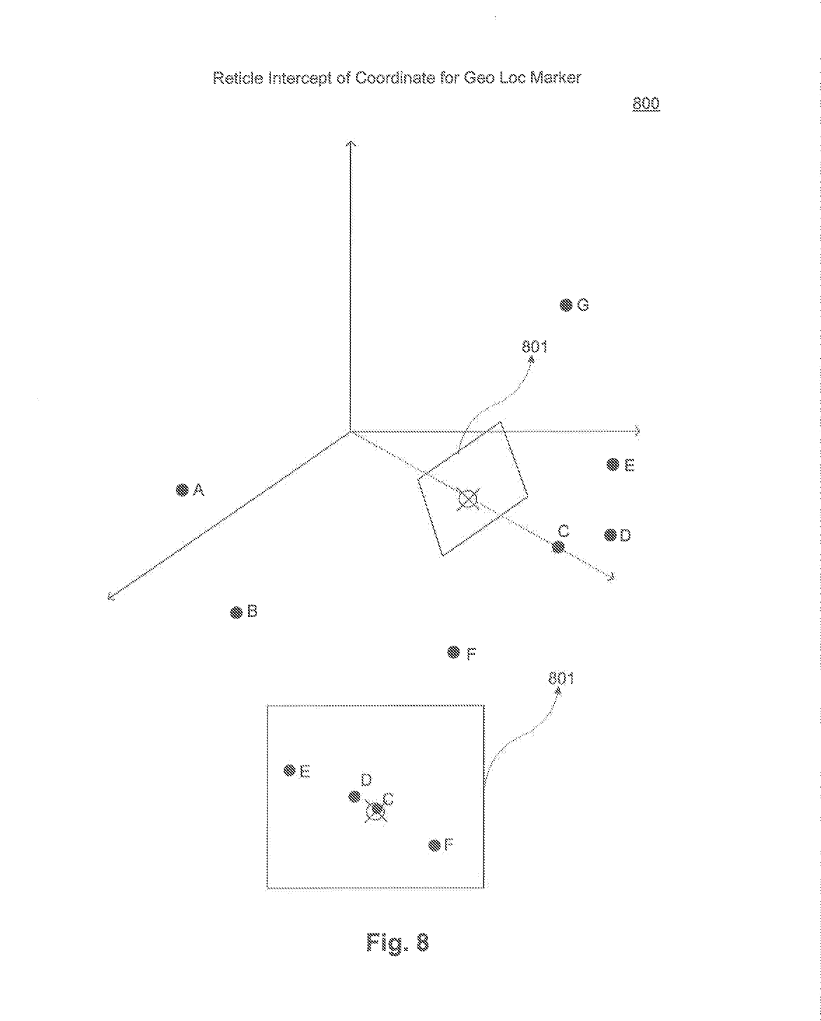

FIG. 8 is a diagrammatic representation of an interception 800 of a geo-located marker by a reticle consistent with the exemplary disclosed embodiments. As shown in FIG. 8, the field of a user's view 801 includes geo-located markers C, D, E, and F. In the field of the user's view 801, the reticle is overlapped with geo-located marker C. As a result, the HMD device may determine that geo-located marker C is selected. When a geo-located marker is intercepted by the reticle in the coordinate system, it may be selected for further action.

To indicate or confirm a selection, feedback to the user may be provided by the system, including but not limited to the marker or reticle changing color, shape or form, additional information presented on the display, haptic feedback on a separate device, an audio sound, etc. In response to selection, various interactions may occur. For example, in some embodiments, selection of a marker may cause an interaction to take place, including but not limited to, presenting menu options for the user, displaying information and metadata about the marker, triggering some transaction or behavior in another system or device. In some embodiments, a marker may be associated with a person, and selection of the marker may initiate a communication (e.g., a phone call or video call) to the person.

Geo-located markers need not always be associated with objects, locations, etc. having fixed locations. For example, such markers may be associated with people or other movable objects, such as cars, vehicles, personal items, mobile devices, tools, or any other movable object. The position of such movable objects may be hacked, for example, with the aid of various position locating sensors or devices, including GPS units.

Further, geo-located objects can be defined at any time through a multitude of processes. For example, a user may identify an object and designate the object for inclusion into the tracking database. Using one or more input devices (e.g., input keys, keyboard, touchscreen, voice controlled input devices, gestures of the hand etc., a mouse, pointers, joystick, or any other suitable input device), the user may also specify the coordinate location, metadata, object information or an action or actions to be associated with the designated object. Designation of geo-located objects for association with geo-located markers may also be accomplished dynamically and automatically. For example, if processor device 123 or processor device 111 recognizes a QR code within a field of view of the HMD 200, then such a code may initiate generation of a geo-located marker associated with one or more objects within the field of view. Similarly, if processor device 123 or processor device 111 recognizes a certain object or object type (e.g, based on image data acquired from the user's environment), then a geo-located marker can be created and associated with the recognized object. Further still, geo-located markers may be generated according to predefined rules. For example, a rule may specify that a geo-located marker is to be established and made available for display at a certain time and at a certain location, or relative to a certain object, person, place, etc. Additionally, when a user logs into a system, the user may be associated with a geo-located marker.

Processing associated with defining geo-located markers, identifying geo-located markers to display, or any other functions associated with system 100 may be divided among processor devices 111 and 123 in any suitable arrangement. For example, in some embodiments, HMD 200 can operate in an autonomous or semi-autonomous manner, and processing device 123 may be responsible for most or all of the functions associated with defining, tracking, identifying, displaying, and interacting with the geo-located markers. In other embodiments, most or all of these tasks may be accomplished by processor device 111 on server system 110. In still other embodiments these tasks may be shared more evenly between processor device 111 and processor device 123. In some embodiments, processor device 111 may send tracking information to HMD 200, and processor 123 may handle fee tasks of determining location, orientation, field of view, and vector intersections in order to update the display of HMD 200 with geo-located markers and enable and track selection, or interactions with those markers.

In some embodiments, the set of geo-located markers displayed on HMD 200 may be determined, as previously noted, based on an intersection of the user's field of view with locations of tracked items associated with geo-located markers. Other filtering schemes, however, are also possible. For example, in some embodiments, only those geo-located markers within a certain distance of the user (e.g., 10 m, 20 m, 50 m, 100 m, 1 mile, 10 miles, etc) will be displayed on the user's field of view. In another embodiment, only those geo-located markers of a certain type or associated with, certain metadata (e.g., another user in a user's “contact list”) will be displayed on the user's field of view.

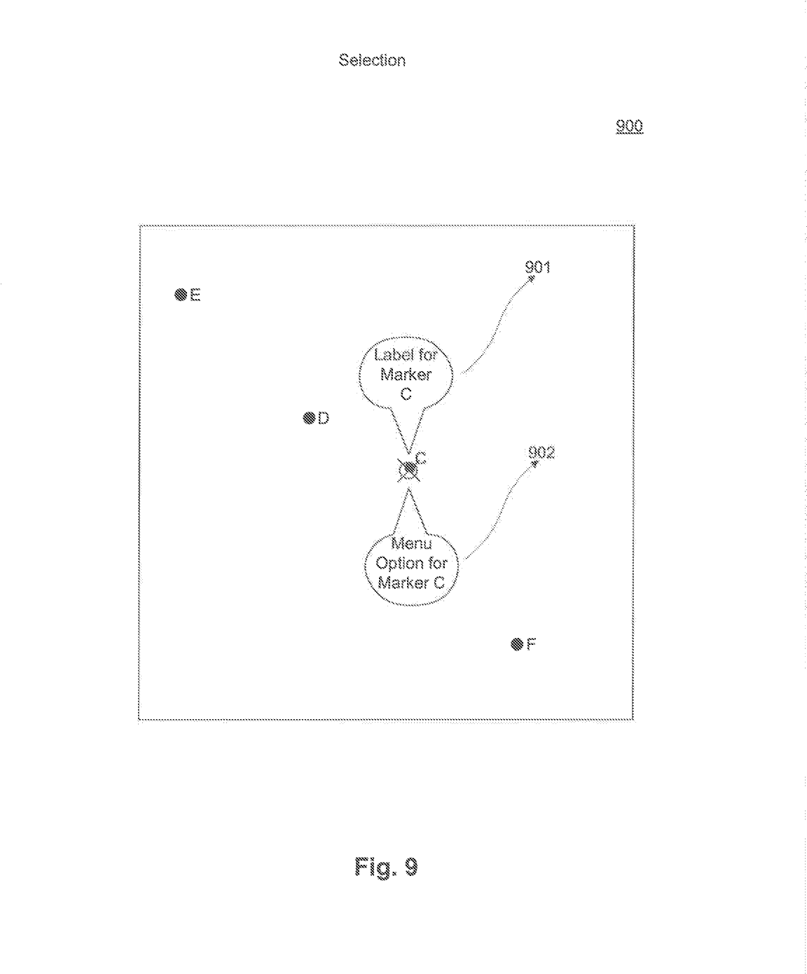

FIG. 9 is a diagrammatic representation of a selection outcome 900 consistent with the exemplary disclosed embodiments. For example, if in the user's field of view are a series of mountain peaks which the user can see through a semi-transparent lens, and at the top of each peak is a digitally rendered icon representing individual geo-located objects, and in the center of the field of view is a ‘cross hairs’ reticle acting as a visual guide for the user, then when the user moves the HMD to align the cross-hairs on the display to one of the icons, and holds the reticle at that spot for some amount of time (e.g., 1 second), additional information about that specific peak may be displayed. For example, a label 901 may be displayed including information and metadata about Marker C, or an application menu 902 presenting options for choosing information, directions, current weather may be provided. In some embodiments, alternative or in addition to displaying additional information of the geo-located objects, commands may be sent in response to selection of a geo-located object by the user. For example, by moving the HMD to align the cross-hairs on the display to a geo-located object to select the geo-located object, the user may send a command to the person, place, object, etc. associated with the selected geo-located object. The commands may include, for example, commands to turn on/off or otherwise control a component associated with the person, place, object, etc. The commands may also include directions for moving to a new location, instructions for completing a task, instructions to display a particular image (e.g., one or more images captured from HMD 200 of the user), or any other command mat may cause a change in state of the object, person, place, etc. associated with the selected geo-located marker.

In another example, in the user's field of view an icon is rendered to represent the location of a colleague 100 miles away, and when the user aligns the cross-hairs reticle on the icon and holds it for 0.5 seconds, a menu option to initiate a phone call to that colleague may be presented to the user. In yet another example, in the user's field of view an icon is rendered to represent a piece of equipment which is connected to a communications network, and when the user aligns the cross-hairs reticle on the icon and holds it for 1.5 seconds, a command is sent from either the server system or the user system to turn the equipment on or off.

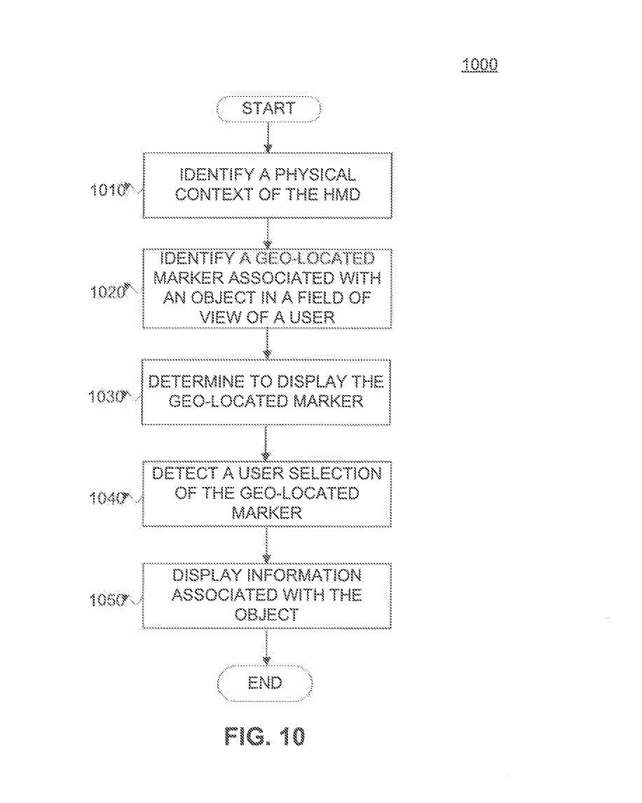

FIG. 10 is a flowchart of an exemplary process 1000 for displaying information on a HMD device, consistent with disclosed embodiments. As an example, one or more steps of process 1000 may be performed by the HMD device. At step 1010, the HMD device may identify a physical context of the HMD, such as the location of the HMD, the orientation of the HMD, etc. At step 1020, the HMD may identify a geo-located marker associated with an object in a field of view of a user based on the physical context of the HMD. In some embodiments, the HMD may utilize information stored inside the HMD to determine the geo-located marker based on the physical context of the HMD. In some other embodiments, the HMD may receive information associated with the geo-located marker from the server system. At step 1030, the HMD may determine to display the geo-located marker such that the geo-located marker is visible to the user wearing the HMD. At step 1040, the HMD may detect a user selection of the geo-located marker, for example, by detecting an overlapping of the reticle with the geo-located marker. At step 1050, the HMD may display information associated with the object in response to the detection of the user selection. For example, the HMD may display metadata associated with the object or display a menu option for the user to select.

It should be further understood that arrangements described herein are for purposes of example only. As such, those skilled in the art will appreciate that other arrangements and other elements (e.g. machines, interfaces, functions, orders, and groupings of functions, etc) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

While various aspects and embodiments have been disclosed herein, other aspects and embodiments will he apparent to those skilled in the art. The various aspects and embodiments disclosed herein are for purposes of illustration and are not intended to be limiting, with the true scope being indicated by the following claims, along with the Ml scope of equivalents to which such claims are entitled. It is also to be understood that the terminology used herein is for the purpose of describing particular embodiments only, and is not intended to be limiting.

What is claimed is:

1. A method for displaying information by a head mounted display (HMD), comprising:
identifying a physical context of the HMD;
identifying, based on the physical context, a geo-located marker associated with an object in a field of view of a user;
displaying the geo-located marker on the HMD;
detecting a user selection of the geo-located marker; and
displaying information associated with the object.

2. The method of claim 1, wherein displaying information associated with the geo-located marker includes superimposing the information associated with the object over the field of view of the user.

3. The method of claim 1, further comprising obtaining the information associated with the object from a computer application.

4. The method of claim 1, wherein the information associated with the object is displayed in close proximity to the geo-located marker.

5. The method of claim 1, wherein the physical context of the HMD is identified based on output of one or more sensors associated with the HMD.

6. The method of claim 1, further comprising displaying a reticle, wherein the reticle represents a fixed point of reference relative to the HMD.

7. The method of claim 6, wherein detecting a user selection of the geo-located marker includes detecting an interception of the reticle with the geo-located marker.

8. The method of claim 1, wherein identifying a physical context of the HMD includes identifying a location of the HMD in a two dimensional or three dimensional coordinate system.

9. The method of claim 1, wherein the physical context of the HMD includes at least one of:
a location of the HMD;
an orientation of the HMD; and
a bearing of the HMD.

10. The method of claim 1, wherein the information associated with the object includes a menu option associated with the object.

11. The method of claim 1, wherein the information associated with the object includes instructions or commands which are sent to the object.

12. A head mounted display (HMD) comprising:
a display configured to transmit at least some visible light; and
a processor device, wherein the processor device is configured to:
identify a physical context of the HMD;
identify a geo-located marker associated with an object in a field of view of a user, the geo-located marker having been selected for display on the HMD based on the physical context of the HMD;
display the geo-located marker on the HMD;
detect a user selection of the geo-located marker; and
display information associated with the object in response to the detected user selection.

13. The HMD of claim. 12, wherein displaying information associated with the geo-located marker includes superimposing the information associated with the object over the field of view of the user.

14. The HMD of claim 12, wherein the processor device is further configured to:
obtain the information associated with the object from a computer application.

15. The HMD of claim 12, wherein the information associated with the object is displayed in close proximity to the geo-located marker.

16. The HMD of claim 12, further comprising one or more sensors, and wherein identification of the physical context of the HMD is based on output of the one or more sensors.

17. The HMD of claim 12, wherein the processor device is further configured to:
cause a reticle to be displayed on the HMD, wherein the reticle provides a fixed point of reference to the user.

18. The HMD of claim 17, wherein detecting a user selection, of the geo-located marker includes detecting an interception of the reticle with the geo-located marker.

19. The HMD of claim 12, wherein, identifying a physical context of the HMD includes identifying a location of the HMD in a two dimensional or three dimensional coordinate system.

20. The HMD of claim 19, wherein the physical context of the HMD includes at least one of:
a location of the HMD;
an orientation of the HMD; and
a bearing of the HMD.

21. The HMD of claim 12, wherein the information associated with the object includes a menu option associated with the object.

22. The HMD of claim 12, wherein the information associated with the object includes instructions or commands which are sent to the object.
